(19) United States
(12) Patent Application Publication
(10) Pub. No.: US 2012/0145000 A1
(43) Pub. Date: Jun. 14, 2012

(54) Drying Process For Flue Gas Treatment

(75) Inventors: Trapti Chaubey, Wilmington, DE (US); Jean-Pierre Tranier, L'Hay-Les-Roses (FR); Paul Terrien, Philadelphia, PA (US)

(73) Assignee: L'Air Liquide Societe Anonyme Pour L'Etude Et L'Exploitation Des Procedes Georges Claude, Paris (FR)

(21) Appl. No.: 12/965,056

(22) Filed: Dec. 10, 2010

(51) Int. Cl. B01D 53/02

(52) U.S. Cl. 95/148; 96/144; 96/134

(57) ABSTRACT

An apparatus and method for drying a moist gas is provided. The apparatus includes a revolving desiccant rotor with at least an adsorption sector and a regeneration chamber; the regeneration chamber comprising at least a first dry gas sector, a hot regeneration sector, and a second dry gas sector, and optionally a cold regeneration sector. The method includes at least an adsorption sector and a regeneration chamber; the regeneration chamber comprising at least a first dry gas sector, a hot regeneration sector, and a second dry gas sector, and optionally a cold regeneration sector. This method includes the steps of; contacting a moist gas stream with the desiccant in the adsorption sector, thereby producing a dry gas stream; contacting a first dry gas stream with the desiccant in the first dry gas sector, thereby producing a first wet gas stream; contacting a hot partially wet gas stream with the desiccant in the hot regeneration sector, thereby producing a warm wet gas stream; contacting a dry regeneration gas stream with the desiccant in the second dry gas sector, thereby producing a wet regeneration gas stream, and contacting a regeneration purge gas stream with the desiccant in the cold regeneration sector, thereby producing a warm purge gas stream.

### BACKGROUND

The combustion of fossil fuels like coal or natural gas is commonly used to provide heat required for many different industrial processes including electricity generation, hydrogen production, steel making etc. The combustion process involves burning of carbon containing species in the presence of oxygen to produce heat, carbon dioxide, water along with other pollutants like SOx, NOx, mercury etc. It is well known that carbon dioxide is a greenhouse gas causing climate change and many government regulations are underway to prevent carbon dioxide emissions.

Carbon Capture and Sequestration (CCS) is one of the most promising routes to capture carbon dioxide and sequester in under ground geologic formations or use for enhanced oil recovery application etc. However, there is limitation on the amount of gas that can be stored under ground and hence pure carbon dioxide is preferred for storage in order to maximize the utility of the storage space. Power plants are considered to be one of the biggest source for carbon dioxide emission. Conventional air fired boilers use air as an oxidant for the combustion process and produces flue gas with between 10% and 16% carbon dioxide content. Amine solvents are well known to be used for capturing carbon dioxide from the post combustion process. However, the amount of regeneration energy needed for solvent regeneration is very high and decreases the efficiency of overall capture process.

Oxy-combustion is one of the most promising technologies to capture carbon dioxide from power plants. Oxy-combustion involves the use of essentially pure oxygen (>89% purity) instead of air for the combustion process, thereby concentrating the amount of carbon dioxide in the flue gas to more than about 70% to about 80% content. Nitrogen is essentially eliminated from the process since it does not participate in the combustion process and dilutes the amount of carbon dioxide in flue gas in the air fired boiler. The use of pure oxygen can increase the flame temperature significantly hence carbon dioxide is usually recycled back to the boiler in order to maintain similar flame characteristics as the air fired boiler.

Flue gas from oxy-fired boiler contains more than about 70% to about 80% (dry basis) carbon dioxide with other compounds including but not limited to nitrogen, oxygen, argon, SOₓ, NOₓ, mercury, water vapor etc. The amount of carbon dioxide will depend on air infiltration, oxygen purity and coal composition. New power plants can be designed to minimize the air infiltration inside the boiler. Flue gas can be further treated to remove all the impurities and produce pure carbon dioxide for capture in a carbon dioxide Compression and Purification Unit (CPU).

The CPU system generally consists of low pressure impurity removal, compression, high pressure impurity removal followed by optional partial condensation and distillation. Moisture in the flue gas can react with SOₓ, NOₓ and CO₂ at high pressure to form sulfuric acid, nitric acid or carbonic acid along with other compounds. It can also cause corrosion problem inside the compressor, freeze at cold conditions inside the cold box etc. Flue gas drying is very critical in order to avoid corrosion, unwanted reactions or freezing at cold conditions.

Thermal swing adsorption systems (TSA) using adsorbent at high pressure have commonly been employed to remove moisture from flue gas. However, moisture removal at high pressure can lead to corrosion at the upstream process and also require acid condensate handling procedures. Flue gas drying at low pressure can solve the corrosion problem with equipments. However traditional means of drying, such as fixed adsorption beds, are not economical because of reduced adsorption loading capacity.

### SUMMARY

An apparatus and method for drying a moist gas is provided. The apparatus includes a revolving desiccant rotor with at least an adsorption sector and a regeneration chamber; the regeneration chamber comprising at least a first dry gas sector, a hot regeneration sector, and a second dry gas sector, and optionally a cold regeneration sector. The method includes at least an adsorption sector and a regeneration chamber; the regeneration chamber comprising at least a first dry gas sector, a hot regeneration sector, and a second dry gas sector, and optionally a cold regeneration sector This method includes the steps of; contacting a moist gas stream with the desiccant in the adsorption sector, thereby producing a dry gas stream; contacting a first dry gas stream with the desiccant in the first dry gas sector, thereby producing a first wet gas stream; contacting a hot partially wet gas stream with the desiccant in the hot regeneration sector, thereby producing a warm wet gas stream; contacting a dry regeneration gas stream with the desiccant in the second dry gas sector, thereby producing a wet regeneration gas stream, and contacting a regeneration purge gas stream with the desiccant in the cold regeneration sector, thereby producing a warm purge gas stream.

### BRIEF DESCRIPTION OF THE FIGURES

FIG. 1 illustrates an overall representation carbon dioxide capture using oxy-combustion and CPU as known in the art.

FIG. 2 illustrates an overall representation of a CPU as known in the art.

FIG. 3 illustrates the basic layout of the rotating desiccant in accordance with one embodiment of the present invention.

FIGS. 4a and 4b illustrates a more detailed layout of the rotating desiccant in accordance with one embodiment of the present invention.

FIG. 5 illustrates the overall process stream flow rates, as pertaining to the rotating desiccant, in accordance with one embodiment of the present invention.

FIG. 6 illustrates one embodiment of the present invention, in an overall CPU layout.

FIG. 7 illustrates one embodiment of the present invention, in an overall CPU layout, with a fixed bed dryer.

FIG. 8 illustrates one embodiment of the present invention, in an overall CPU layout, with a CO2scrubber.

### DESCRIPTION OF PREFERRED EMBODIMENTS

Illustrative embodiments of the invention are described below. While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The present invention utilizes a revolving desiccant rotor at low pressure to remove moisture from a wet gas (such as a flue gas). A desiccant rotor is a continuous drying process with a portion of the rotor in an adsorption mode and a portion of wheel in a regeneration mode concurrently. Flue gas drying can be accomplished in a single stage at low pressure or multiple stages in combination with high pressure drying. For a single stage drying using desiccant rotor, the flue gas drying is accomplished using at least one rotating desiccant wheel in order to avoid moisture condensation in the downstream processes. In a multiple stage flue gas drying solution, the desiccant rotor can be used in combination with high pressure fixed bed or high pressure liquid carbon dioxide scrubbing column or any other high pressure drying technique. The first stage drying using the desiccant rotor is to ensure that the dried flue gas is well below saturation at the operating condition of units in between the two drying units in order to avoid moisture condensation. The second stage drying is to remove remaining moisture at high pressure using high pressure drying techniques and avoid moisture condensation in the downstream processes.

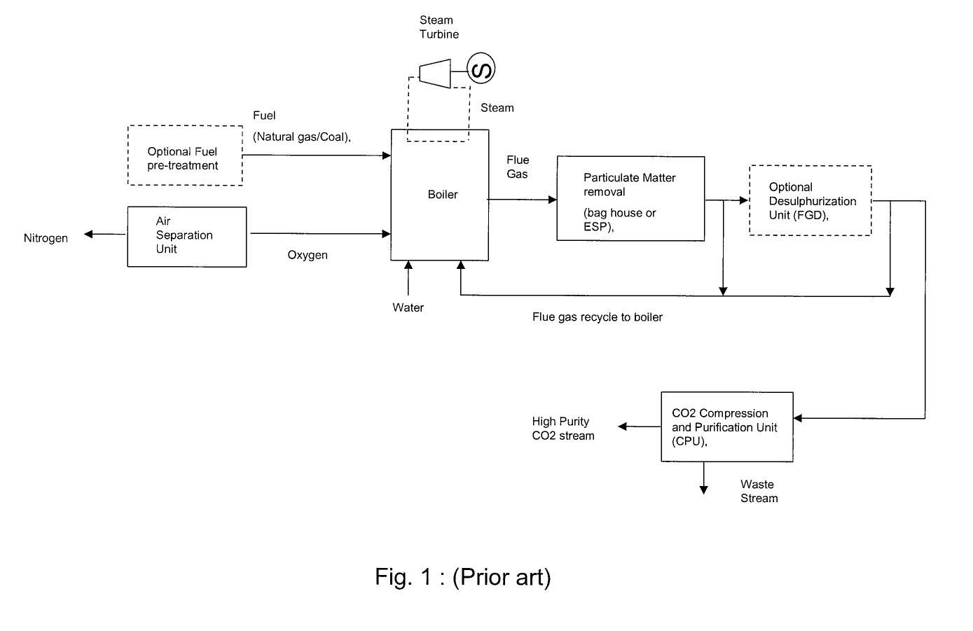

Carbon dioxide capture using oxy-combustion and CPU is well known in the art, as represented in FIG. 1. An air separation unit (ASU) is typically used to provide oxygen at >89% purity to the boiler. Other oxygen production units, for example ion transport membrane could also be employed for oxygen production. Pulverized coal or natural gas is used as fuel for the boiler. Flue gas from oxy-fired boiler is concentrated in carbon dioxide. A portion of flue gas is optionally recycled back to the boiler in order to maintain similar flame characteristics as the air-fired boiler with remaining portion sent for purification to CPU. Flue gas at the exit of the boiler undergoes pre-treatment such as particulate matter removal using bag house or electrostatic precipitator and optional sulfur removal using desulfurization unit before entering the CPU. Flue gas recycle consists of primary recycle and secondary recycle stream. The recycle stream could be from downstream of particulate removal unit or downstream of desulfurizer unit.

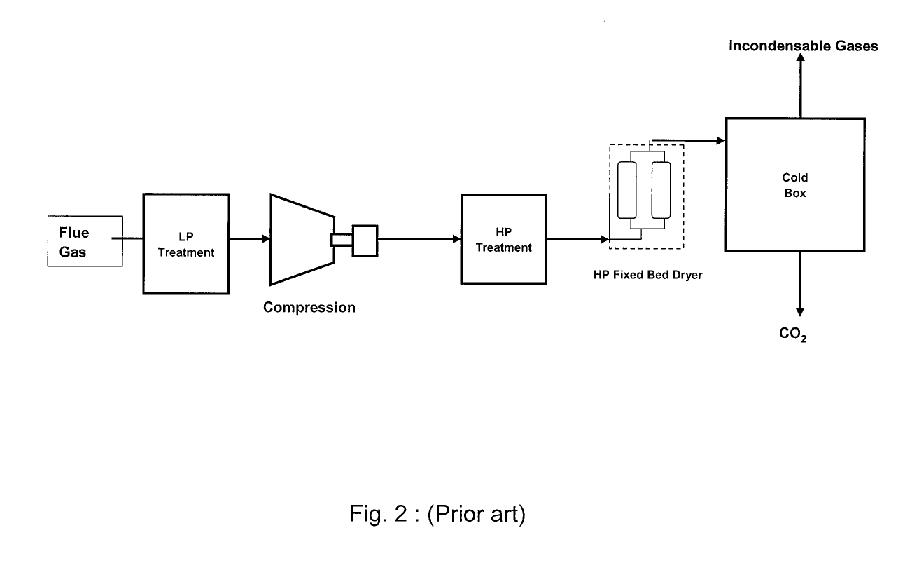

The CPU process, as represented in FIG. 2, involves the use of low pressure impurity removal unit to remove remaining sulfur at low pressure using scrubber unit or any other sulfur removal technique. Flue gas is further compressed using multiple compression stages to high pressure typically ranging from about 10 bar to about 200 bar. The compression step is followed by high pressure impurity removal including metal impurities removal e.g. mercury removal. Moisture removal is done at high pressure using fixed bed adsorption columns with Thermal Swing Adsorption (TSA) process. It employs the use of two beds filled with adsorbents such as. silica gel, molecular sieve or activated carbon. The TSA cycle could consist of several steps such as elution step, pressurization step, regeneration heating step, regeneration cooling step, adsorption step etc. Optionally, flue gas is further treated in a cryogenic process at low temperatures from about −60 C to about −20 C using partial condensation columns and distillation column to separate carbon dioxide from other non-condensable gases.

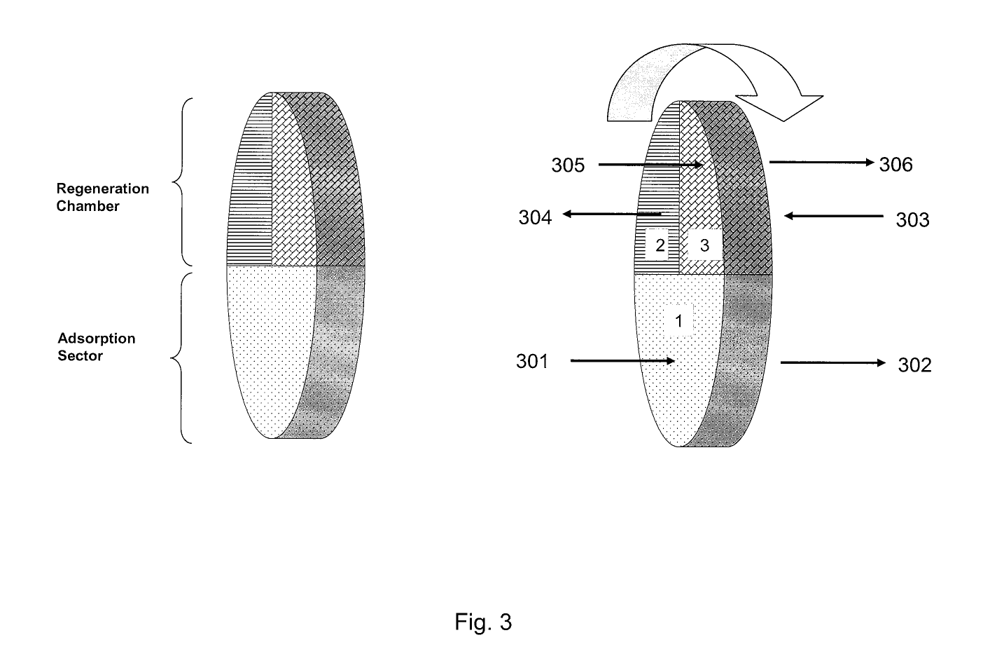

Referring now to FIG. 3, the present invention uses a desiccant rotor for drying at low pressure before the compression step. The desiccant rotor operates on the principle of continuous adsorption and regeneration. The desiccant rotor contains adsorbent such as a silica gel or a molecular sieve or any other adsorbent known in the art to adsorb moisture from a wet gas (such as a flue gas). The desiccant rotor could be any shape, possibly circular. The prior art that deals with air drying where the system requirements and specifications is very different than those presented herein.

A portion of the rotor is in the adsorption mode (Sector 1) and a portion of the rotor in the regeneration mode (Sector 2 and Sector 3). Regeneration could consist of several stages including, but not limited to, hot regeneration and cold regeneration etc. The rotor may consist of an adsorption sector and a regeneration chamber. In its most basic form, the regeneration chamber may consist of a hot regeneration sector (Sector 2) and optionally a cold regeneration sector (Sector 3). As the rotating desiccant wheel enters the regeneration phase, a dry hot gas is introduced into the First Dry Gas Sector, in order to preheat the adsorbent and prepare it for desorption. A hot partially wet gas stream then enters the Hot Regeneration Sector, which further heats the adsorbent and begins the regeneration. Then a hot dry gas is introduced into the Second Dry Gas to complete the regeneration process

The rotor section in the adsorption mode could vary from 40% to 80% preferable from 45% to 65% and more preferable from 50% to 60%. The rotor section in hot regeneration mode could vary from 10% to 50% preferable from 15% to 35% and more preferably from 20% to 30%. The rotor section in cold regeneration mode could vary from 10% to 50% preferable from 15% to 35% and more preferably from 20% to 30%. Cold regeneration step may be optional depending on the desired moisture content in the process output gas.

In one embodiment of the present invention, a moist gas stream (for example, a flue gas) 301 enters the adsorption sector (Sector 1), comes in contact with dry, regenerated adsorbent and exits as dry gas stream 302. Simultaneously, a hot partially wet gas stream 303 enters the hot regeneration sector (Sector 2), comes in contact with an adsorbent to be regenerated, and exits as warm wet gas stream 304. And also simultaneously, a regeneration purge gas stream 305 may enter the cold regeneration sector (Sector 3), comes in contact with partially regenerated adsorbent, and exits as a warm purge gas stream 306.

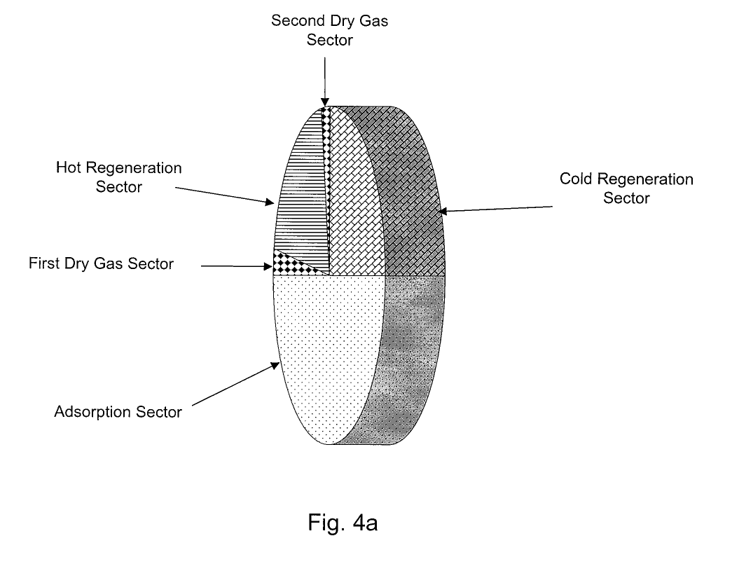

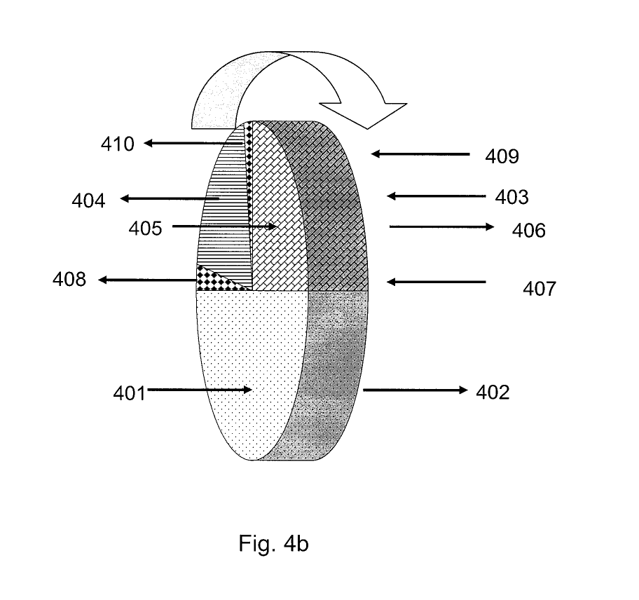

The flow of process gas and regeneration gas could be co-current or counter-current, preferably co-current for process gas and cold regeneration gas and counter-current with hot regeneration gas. The hot regeneration gas could be hot flue gas directly from the boiler or heated non-condensable gas from cold box or heated nitrogen from ASU or heated dry process gas (flue gas). As indicated in FIG. 4a and FIG. 4b, the hot regeneration may be performed in stages using a combination of hot dry and hot partially wet gas. The rotor may consist of an adsorption sector and a regeneration chamber. The regeneration chamber may consist of a first dry gas sector, a hot regeneration sector, and a second dry gas sector. The regeneration chamber may also include a cold regeneration sector. The hot dry gas may be used to preheat the adsorbent in order to avoid moisture condensation from the hot partially wet gas. The moisture condensation on the adsorbent could potentially destroy the adsorbent. The pre-heating stage with hot dry gas can be avoided if water resistant adsorbent is used for drying. The heat for the regeneration gas could be provided by using steam or boiler feed water or any other hot gas.

In another embodiment of the present invention, a moist gas stream (for example, a flue gas) 401 enters the adsorption sector (Sector 1), comes in contact with dry, regenerated adsorbent and exits as dry gas stream 402. Simultaneously, a first dry gas stream 407 enters the first dry gas sector of the hot regeneration sector, comes in contact with an adsorbent to be regenerated, and exits as a first wet gas stream 408. Simultaneously, a hot partially wet gas stream 403 enters the hot regeneration sector (Sector 2), comes in contact with an adsorbent to be regenerated, and exits as warm wet gas stream 404. And also simultaneously, a regeneration purge gas stream 405 may enter the cold regeneration sector (Sector 3), comes in contact with partially regenerated adsorbent, and exits as a warm purge gas stream 406.

The cold regeneration gas could be a slip stream from dry process gas from the desiccant rotor or non-condensable gas from cold box or nitrogen from ASU. The wet process gas is dried in the rotor during adsorption mode and the outlet dry process gas is further sent to CPU. The hot regeneration gas is used to desorb moisture from the adsorbent where the temperature of regeneration gas decreases. The hot regeneration gas from the outlet of the rotor can be either recycled back to CPU for processing or recycle back to boiler in case flue gas is used for hot regeneration gas. The cold regeneration gas is used to cool down the adsorbent before further adsorption in order to increase the adsorption capacity. The cold regeneration gas from the outlet of the rotor can be either recycled back to CPU for processing or recycle back to boiler in case flue gas is used for cold regeneration gas.

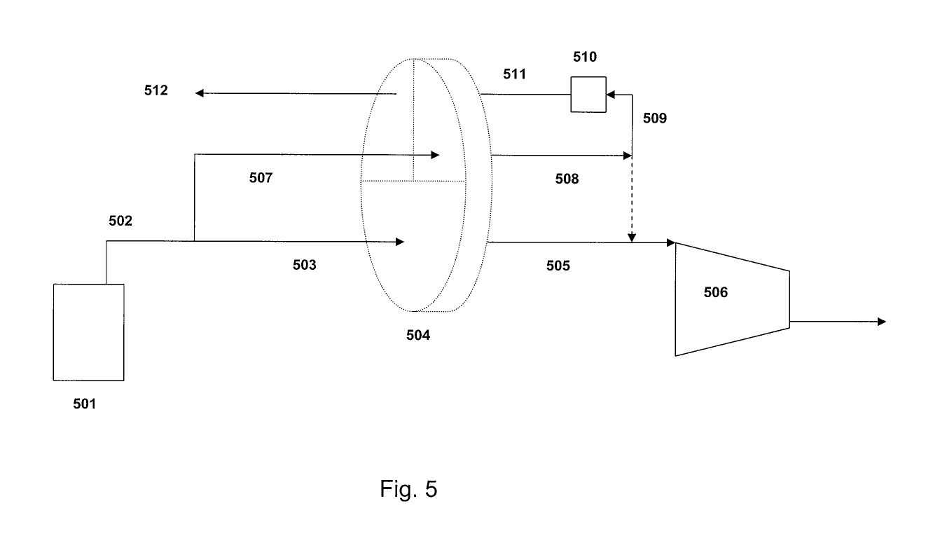

FIG. 5 indicates the basic layout of one embodiment of the present invention. Boiler 501 produces flue gas stream 502. Any cooling or cleaning that may be necessary is not show in this figure. Flue gas stream 502 is split into moist gas stream 503 and regeneration purge gas stream 507. Moist gas stream 503 passes through the revolving desiccant rotor 504 in accordance with the above discussions, and exits as dry gas stream 505. Dry gas stream 505 then proceeds to compressor 506, and beyond as discussed below.

Regeneration purge gas stream 507 then passes through the revolving desiccant rotor 504 in accordance with the above discussions and exits as warm purge gas stream 508. At least a portion 509 of warm purge gas stream 508 is directed to heater 510, where it exits as hot partially wet gas stream 511. Hot partially wet gas stream 511 then passes through the revolving desiccant rotor 504 in accordance with the above discussions and exits as warm wet gas stream 512. Other configurations are possible, and would not require undue experimentation to the skilled artisan. For example, heater 510 may be directly incorporated in the revolving desiccant rotor 504.

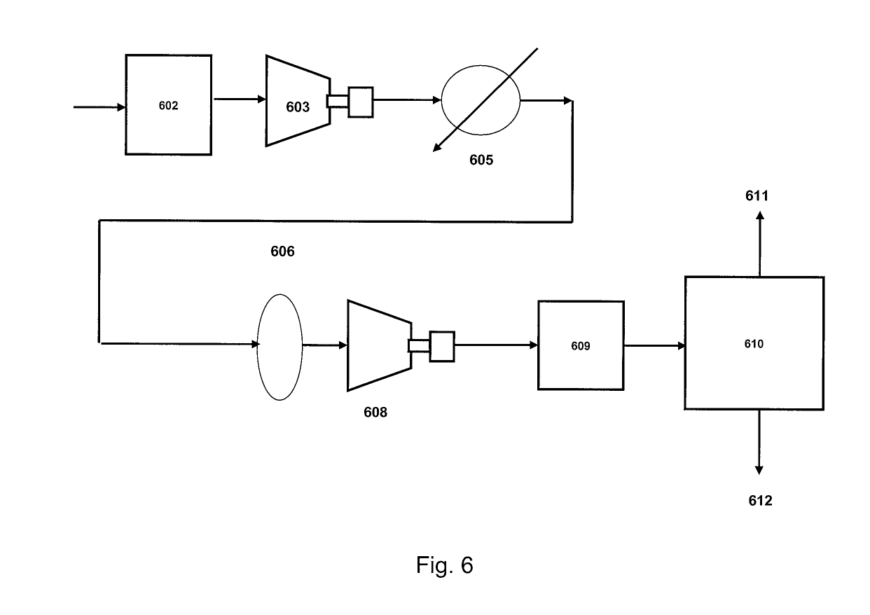

The desiccant rotor may be incorporated into a conventional CPU system in a number of ways depending on the specific need, and none of which would require undue experimentation for the skilled artisan. In one embodiment, as indicated in FIG. 6, the low pressure desiccant rotor 601 can be used to remove moisture in a one stage drying process, where sufficient moisture is removed in order to avoid condensation in the downstream process. The low pressure desiccant rotor 601 could use a single adsorbent or combination of adsorbents to remove moisture. The multi adsorbent system could be incorporated in a single rotor or series of rotor to remove moisture (not indicated). The first adsorbent could be selected from the group of acid resistant adsorbent such as a silica gel and second adsorbent could be high capacity adsorbent such as a molecular sieve.

A moist gas stream (for example, a flue gas stream) 601 enters a Low Pressure (LP) cooler and polisher 602. The output from the LP cooler and polisher 602 has the pressure boosted by booster fan 603, and cooled in first heat exchanger 605. The resulting moist gas stream is then introduced to desiccant rotor 606, as discussed and described above. The resulting dry gas stream is then compressed in compressor 608 and cooled in second heat exchanger 609. The resulting stream is then admitted into the cold box 610, thereby producing incondensable gas stream 611 and CO2 stream 612.

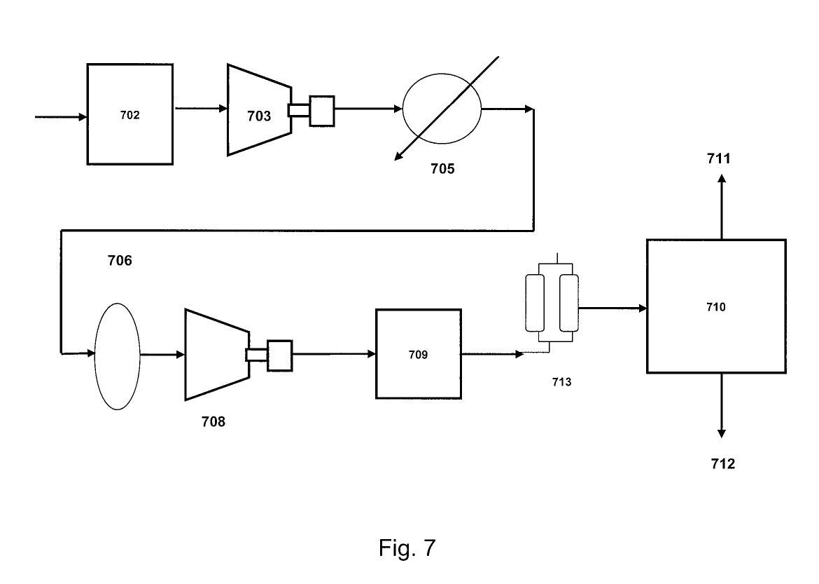

As indicated in FIG. 7, the low pressure desiccant rotor can also be combined with other drying techniques at high pressure to remove moisture in two stages. The first stage moisture removal is by using desiccant rotor at low pressure to remove enough moisture in order to avoid condensation inside the compressors at high pressure, in particular to avoid condensation at operating conditions before the second stage moisture removal unit. The second stage moisture removal unit could be high pressure fixed bed (TSA) unit employing two beds to remove moisture with one bed in adsorption mode and second bed in regeneration mode. The regeneration gas could be dry flue gas or heated non-condensable gas or heated nitrogen. The heat for the regeneration gas could be provided by using steam or boiler feed water or any other hot gas. The cold regeneration gas could be dry flue gas or non-condensable gas or nitrogen.

A moist gas stream (for example, a flue gas stream) 701 enters a Low Pressure (LP) cooler and polisher 702. The output from the LP cooler and polisher 702 has the pressure boosted by booster fan 703, and cooled in first heat exchanger 705. The resulting moist gas stream is then introduced to desiccant rotor 706, as discussed and described above. The resulting dry gas stream is then compressed in compressor 708 and cooled in second heat exchanger 709. The dry, cooled and compressed stream is then introduced into a High Pressure (HP) dryer 713, for example of the fixed bed design. The resulting stream is then admitted into the cold box 710, thereby producing incondensable gas stream 711 and CO2 stream 712.

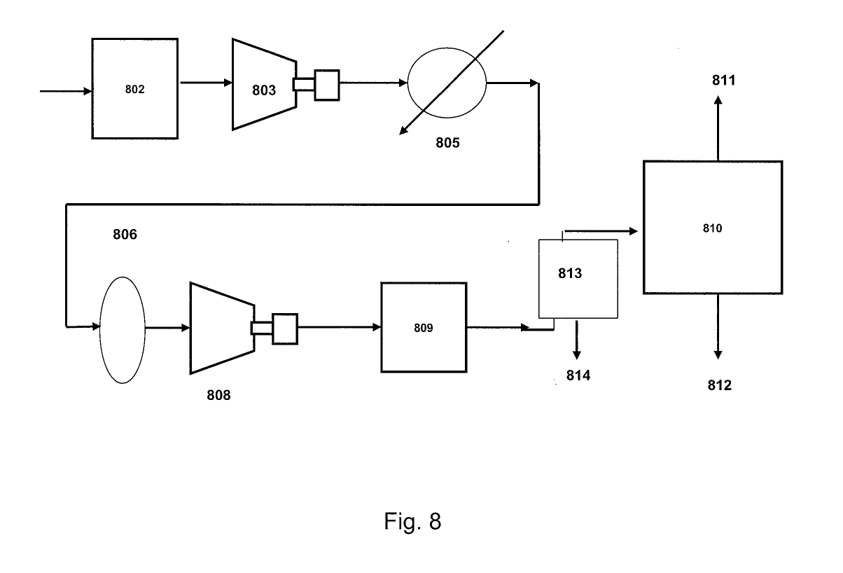

As indicated in FIG. 8, the second stage moisture removal unit could also consist of high pressure liquid carbon dioxide scrubber where remaining moisture is removed by dissolving water in liquid carbon dioxide at cold conditions in the NOx scrubber column.

A moist gas stream (for example, a flue gas stream) 801 enters a Low Pressure (LP) cooler and polisher 802. The output from the LP cooler and polisher 802 has the pressure boosted by booster fan 803, and cooled in first heat exchanger 805. The resulting moist gas stream is then introduced to desiccant rotor 806, as discussed and described above. The resulting dry gas stream is then compressed in compressor 808 and cooled in second heat exchanger 809. The dry, cooled and compressed stream is then introduced into a High Pressure (HP) carbon dioxide scrubber 813, which produces a waste water stream 814. The resulting stream is then admitted into the cold box 810, thereby producing incondensable gas stream 811 and CO2 stream 812.

What is claimed is:

1. An apparatus for drying a moist gas comprising, a revolving desiccant rotor comprising at least an adsorption sector and a regeneration chamber; said regeneration chamber comprising at least a first dry gas sector, a hot regeneration sector, and a second dry gas sector.

2. The apparatus of claim 1, wherein said regeneration chamber further comprises a cold regeneration sector.

3. The apparatus of claim 1, wherein said sectors are sequentially positioned in the direction of rotor revolution.

4. The apparatus of claim 2, wherein said sectors are sequentially positioned in the direction of rotor revolution, with said cold regeneration sector coming after said second dry gas sector, and before said adsorption sector.

5. The apparatus of claim 2, further comprising a low pressure cooler and polisher, a booster fan, a first heat exchanger, a compressor, and a second heat exchanger.

6. The apparatus of claim 5, further comprising a high pressure dryer.

7. The apparatus of claim 6, wherein said high pressure dryer is a fixed bed design.

8. The apparatus of claim 5, further comprising a high pressure carbon dioxide scrubber.

9. The apparatus of claim 2, wherein said adsorption sector comprises between about 40% and about 80% of the desiccant rotor.

10. The apparatus of claim 9, wherein said adsorption sector comprises between about 45% and about 65% of the desiccant rotor.

11. The apparatus of claim 9, wherein said adsorption sector comprises between about 50% and about 60% of the desiccant rotor.

12. The apparatus of claim 2, wherein said hot regeneration sector comprises between about 10% and about 50% of the desiccant rotor.

13. The apparatus of claim 12, wherein said hot regeneration sector comprises between about 15% and about 35% of the desiccant rotor.

14. The apparatus of claim 12, wherein said hot regeneration sector comprises between about 20% and about 30% of the desiccant rotor.

15. The apparatus of claim 2, wherein said cold regeneration sector comprises between about 10% and about 50% of the desiccant rotor.

16. The apparatus of claim 15, wherein said cold regeneration sector comprises between about 15% and about 35% of the desiccant rotor.

17. The apparatus of claim 15, wherein said cold regeneration sector comprises between about 20% and about 30% of the desiccant rotor.

18. A method for drying a moist with a revolving desiccant rotor comprising at least an adsorption sector and a regeneration chamber; said regeneration chamber comprising at least a first dry gas sector, a hot regeneration sector, and a second dry gas sector,; comprising the steps of;
a) contacting a moist gas stream with the desiccant in said adsorption sector, thereby producing a dry gas stream;
b) contacting a first dry gas stream with the desiccant in said first dry gas sector, thereby producing a first wet gas stream;
c) contacting a hot partially wet gas stream with the desiccant in said hot regeneration sector, thereby producing a warm wet gas stream; and
d) contacting a dry regeneration gas stream with said desiccant in said second dry gas sector, thereby producing a wet regeneration gas stream.

19. The method of claim 18, wherein steps a) through d) occur concurrently as the desiccant rotor revolves.

20. The method of claim 18, wherein said moist gas stream is counter-current with said hot partially wet gas stream.

21. The apparatus of claim 18, wherein said adsorption sector comprises between about 40% and about 80% of the desiccant rotor.

22. The apparatus of claim 21, wherein said adsorption sector comprises between about 45% and about 65% of the desiccant rotor.

23. The apparatus of claim 21, wherein said adsorption sector comprises between about 50% and about 60% of the desiccant rotor.

24. The apparatus of claim 18, wherein said hot regeneration sector comprises between about 10% and about 50% of the desiccant rotor.

25. The apparatus of claim 24, wherein said hot regeneration sector comprises between about 15% and about 35% of the desiccant rotor.

26. The apparatus of claim 24, wherein said hot regeneration sector comprises between about 20% and about 30% of the desiccant rotor.

27. A method for drying a moist with a revolving desiccant rotor comprising at least an adsorption sector and a regeneration chamber; said regeneration chamber comprising at least a first dry gas sector, a hot regeneration sector, and a second dry gas sector, and a cold regeneration sector; comprising the steps of;
a) contacting a moist gas stream with the desiccant in said adsorption sector, thereby producing a dry gas stream;
b) contacting a first dry gas stream with the desiccant in said first dry gas sector, thereby producing a first wet gas stream;
c) contacting a hot partially wet gas stream with the desiccant in said hot regeneration sector, thereby producing a warm wet gas stream;
d) contacting a dry regeneration gas stream with said desiccant in said second dry gas sector, thereby producing a wet regeneration gas stream, and
e) contacting a regeneration purge gas stream with said desiccant in said cold regeneration sector, thereby producing a warm purge gas stream.

28. The method of claim 27, wherein steps a) through e) occur concurrently as the desiccant rotor revolves.

29. The method of claim 27, wherein said moist gas stream and said regeneration purge gas stream are from the same source.

30. The method of claim 27, wherein said warm purge gas stream is heated, thereby producing said hot partially wet gas stream.

31. The method of claim 27, wherein said moist gas stream is co-current with said regeneration purge gas stream.

32. The method of claim 27, wherein said moist gas stream is counter-current with said hot partially wet gas stream.

33. The apparatus of claim 27, wherein said adsorption sector comprises between about 40% and about 80% of the desiccant rotor.

34. The apparatus of claim 33, wherein said adsorption sector comprises between about 45% and about 65% of the desiccant rotor.

35. The apparatus of claim 33, wherein said adsorption sector comprises between about 50% and about 60% of the desiccant rotor.

36. The apparatus of claim 27, wherein said hot regeneration sector comprises between about 10% and about 50% of the desiccant rotor.

37. The apparatus of claim 36, wherein said hot regeneration sector comprises between about 15% and about 35% of the desiccant rotor.

38. The apparatus of claim 36, wherein said hot regeneration sector comprises between about 20% and about 30% of the desiccant rotor.

39. The apparatus of claim 27, wherein said cold regeneration sector comprises between about 10% and about 50% of the desiccant rotor.

40. The apparatus of claim 39, wherein said cold regeneration sector comprises between about 15% and about 35% of the desiccant rotor.

41. The apparatus of claim 39, wherein said cold regeneration sector comprises between about 20% and about 30% of the desiccant rotor.
